(19) United States
(12) Patent Application Publication
(10) Pub. No.: US 2026/0078067 A1
(43) Pub. Date: Mar. 19, 2026

(54) A SUSPENSION OF SULPHATE SALTS

(71) Applicant: ICL EUROPE COOPERATIEF U.A., Amsterdam (NL)

(72) Inventors: Khalil ABU-RABEAH, Beer Sheva (IL); Avital FEINSTEIN, Kiryat Motzkin (IL); Ruth FRIED, Kfar Haro'e (IL); Amir GERBER, Sheizaf (IL)

(21) Appl. No.: 19/110,076

(22) PCT Filed: Sep. 8, 2023
(86) PCT No.: PCT/IL2023/050971

§ 371 Date: Mar. 9, 2025

Related U.S. Application Data
(60) Provisional application No. 63/404,967, filed on Sep. 9, 2022.

(51) Int. Cl. C05D 1/00; C05D 5/00; C05G 3/30; C05G 5/27

(52) U.S. Cl. CPC C05D 1/00; C05D 5/00; C05G 3/30; C05G 5/27

(57) ABSTRACT

There is provided herein a suspension comprising at least one sulphate salt in a concentration of at least 50% w/w; and at least one suspending agent.

### FIELD OF THE INVENTION

The present invention relates to the field of fertilizers, specifically to production of sulphate salt suspension to act as a fertilizer.

### BACKGROUND OF THE INVENTION

To grow properly, plants need nutrients (nitrogen, phosphorus, potassium, calcium, zinc, magnesium, iron, manganese, etc.) which normally can be found in the soil. Sometimes fertilizers are required to enhance or achieve a desired plant growth stage.

The growth of plants is met by two main modes, the traditional one by which additives provide nutrients. The second mode by which some fertilizers enhance the effectiveness of the soil by modifying its water retention and aeration. Fertilizers typically provide, in varying proportions, three main macronutrients three secondary macro-nutrients, and micro-nutrients. The primary macro-nutrients are:
Nitrogen (N): leaf growth;
Phosphorus (P): Development of roots, flowers, seeds, fruit;
Potassium (K): Strong stem growth, movement of water in plants, promotion of flowering and fruiting;
The secondary macro-nutrients are: Calcium (Ca), Magnesium (Mg), and Sulphur(S);
The micronutrients are: Copper (Cu), Iron (Fe), Manganese (Mn), Molybdenum (Mo), Zinc (Zn), Boron (B), and in occasional significance Silicon (Si), Cobalt (Co), Vanadium (V) and, rare mineral catalysts.

The most reliable and effective way to make nutrients available and coincide with plant requirements is by controlling their release into the soil solution, using slow release or controlled release fertilizers.

Both slow release fertilizers (SRF) and controlled release fertilizers (CRF) supply nutrients gradually. Yet, slow release fertilizers and controlled release fertilizers differ in many ways: The technology they use, the release mechanism, longevity, release controlling factors and more.

Solid fertilizers include granules, prills, crystals and powders. A prilled fertilizer is a type of granular fertilizer that is nearly spherical made by solidifying free-falling droplets in air or a fluid medium. Most controlled-release fertilizers (CRFs) used in commercial nurseries are prilled fertilizers that have been coated with sulfur or a polymer. These products have been developed to allow a slow release of nutrients into the root zone throughout crop development. It is known that sulphate contained compounds differ in water solubility ability.

The most readily soluble and popular sources of sulphate fertilizers are ammonium sulphate (AS), single superphosphate (SSP), potassium sulphate, and magnesium sulphate. Polyhalite is an evaporite mineral, a single complex crystal dehydrated form of sulphate of potassium, calcium and magnesium with formula: K₂Ca₂Mg(SO₄)₄·2H₂O. Polyhalite is used as a fertilizer since it is considered low in chloride and contains both primary macronutrients and secondary macronutrients as follows:
48% SO₃ as sulfate
14% K₂O
6% MgO
17% CaO

The use of liquid fertilizers encompasses various advantages over the use of dry, e.g., granulated or powdered, fertilizers. For example, dry powdered fertilizers tend to scatter, e.g., when winds are present. Also, liquid based fertilizers tend be more homogeneous, and provide an even distribution of the fertilizer to the plants, e.g., in comparison to granulated fertilizers.

However, certain fertilizers, such as polyhalite, tend to precipitate quickly when high concentrations of polyhalite are used in a suspension.

### SUMMARY OF THE INVENTION

According to some demonstrative embodiments, there is provided herein a Sulphate salt suspension and a process for the production thereof.

According to some demonstrative embodiments, there is provided herein a highly concentrated sulphate salt suspension comprising at least 50% w/w salt, preferably, at least 60% w/w, more preferably at least 70% w/w.

According to some embodiments, the sulphate salt may include any mineral selected from the group including Anhydrite, Polyhalite, Gypsum, Kieserite, Epsomite. Glauberite, Blodite, Langbeinite, Kainite, Schonite, Calcium sulphate, potassium magnesium and sulfur fertilizers (e.g., K-Mag®) and the like.

According to some embodiments, the sulphate salt may preferably be Polyhalite.

According to some embodiments, the polyhalite may be produced from the standard grade of polyhalite, i.e., having a particle size of less than 2 mm.

According to some embodiments, the present invention may allow for the formation of a stable suspension using Polyhalite having a particle size of 0.5-2 mm, for example, non-homogeneous or varying particle sizes within the range of 0.5-2 mm.

According to other embodiments, the sulphate salt may preferably be Kieserite.

According to some embodiments, the Kieserite may have a particle size of less than 3 mm.

According to some embodiments, the suspension of the present invention may be stable for at least one month, preferably at least 2 months, more preferably for at least three months.

According to some embodiments, stability of the suspension may be measured by the lack of or the minimal of separation into different layers and/or the lack of or minimal precipitation of a mass.

According to some embodiments, measurement of the stability of the suspension may be conducted via pouring the suspension into a 100 ml tube and measuring the height change due to sedimentation vs. time. A stable suspension is defined as 0 mm change over a minimum of two weeks from preparation, preferably, 1 month from preparation, most preferably, at least 2 months.

According to some embodiments, the suspension of the present invention may include one or more suspending agents, for example, for enabling the creation of a flowable and a stable suspension.

According to some embodiments, the one or more suspending agents may include a suitable thickener or clay.

According to some embodiments, the one or more suspending agents may be in a concentration of between 0.2%-1% w/w.

According to some embodiments, the one or more suspending agents may be selected from the group including organically modified smectite clays; beneficiated smectite clays; Colloidal magnesium aluminum silicates; and gum such as Microcrystalline Cellulose; Cellulose Gums, Xanthan gum, Guar gum and the like.

According to some embodiments, the one or more suspending agents may preferably be a clay, most preferably, an organically modified beneficiated smectite clay.

According to some embodiments, the suspension of the present invention may have a viscosity of about 2000 cP and a density of about 1.9 g/cc.

According to some embodiments, the suspension may further include at least one dispersant selected from the group including nonionic surfactants formed by the ethoxylation of sorbitan; A blend of polyethoxylated alkyl amines (C8-C18) alkyl polyoxyethylene glycols and organic acids; Sodium hexametaphosphate (SHMP); hydrotropes; wetting agents; super-wetting agents; nonionic surfactants; nonionic surfactants that have a hydrophilic polyethylene oxide chain; sodium polymethacrylate dispersing agents and the like.

According to some embodiments, there is provided herein a method for the preparation of a sulphate salt suspension, comprising: Pre-mixing water (for example, reverse osmosis water) with one or more suspending agents via mechanical stirring; Adding said sulphate salt in three steps (equal amounts) while mixing via mechanical stirring; and wherein said sulphate salt is in a concentration of at least 50% w/w.

According to some embodiments, the sulphate salt may be selected from the group including Anhydrite, Polyhalite, Gypsum, Kieserite, Epsomite. Glauberite, Blodite, Langbeinite, Kainite, Schonite, Calcium sulphate, potassium magnesium and sulfur fertilizers.

According to some embodiments, the sulphate salt may preferably be Polyhalite or Kieserite.

According to some embodiments, the clay may be in a concentration of between 0.2%-1% w/w.

### BRIEF DESCRIPTION OF THE DRAWINGS

FIG. 1 depicts vial tests, in accordance with some demonstrative embodiments.

FIG. 2 depicts vial tests, in accordance with some demonstrative embodiments.

FIG. 3—depicts an exemplary polyhalite suspension in accordance with some demonstrative embodiments.

FIG. 4—depicts an exemplary polyhalite suspension in accordance with some demonstrative embodiments.

### DETAILED DESCRIPTION OF THE INVENTION

According to some demonstrative embodiments, there is provided herein a Sulphate salt suspension and a process for the production thereof.

According to some demonstrative embodiments, there is provided herein a highly concentrated sulphate salt suspension comprising at least 50% w/w salt, preferably, at least 60% w/w, more preferably at least 70% w/w.

According to some embodiments, the sulphate salt may include any mineral selected from the group including Anhydrite, Polyhalite, Gypsum, Kieserite, Epsomite. Glauberite, Blodite, Langbeinite, Kainite, Schonite, Calcium sulphate, potassium magnesium and sulfur fertilizers (e.g., K-Mag®) and the like.

According to some embodiments, the sulphate salt may preferably be Polyhalite.

According to some embodiments, the polyhalite may be produced from the standard grade of polyhalite, i.e., having a particle size of less than 2 mm.

According to some embodiments, the present invention may allow for the formation of a stable suspension using Polyhalite having a particle size of 0.5-2 mm, for example, non-homogeneous or varying particle sizes within the range of 0.5-2 mm.

According to other embodiments, the sulphate salt may preferably be Kieserite.

According to some embodiments, the Kieserite may have a particle size of less than 3 mm.

According to some embodiments, the suspension of the present invention may be stable for at least one month, preferably at least 2 months, more preferably for at least three months.

According to some embodiments, stability of the suspension may be measured by the lack or minimal of separation into different layers and/or the lack or minimal precipitation of a mass.

According to some embodiments, measurement of the stability of the suspension may be conducted via pouring a suspension into a 100 ml tube and measuring the height change due to sedimentation vs. time. A stable suspension is defined as 0 mm change over a minimum of two weeks from preparation, preferably, 1 month from preparation, most preferably, at least 2 months.

According to some embodiments, the suspension of the present invention may include one or more suspending agents, for example, for enabling the creation of a flowable and a stable suspension.

According to some embodiments, the one or more suspending agents may include a suitable thickener or clay.

According to some embodiments, the one or more suspending agents may be in a concentration of between 0.2%-1% w/w.

According to some embodiments, the one or more suspending agents may be selected from the group including organically modified smectite clays;

beneficiated smectite clays; Colloidal magnesium aluminum silicates; and

gum such as Microcrystalline Cellulose; Cellulose Gums, Xanthan gum, Guar gum and the like.

According to some embodiments, the one or more suspending agents may preferably be a clay, most preferably, an organically modified beneficiated smectite clay.

According to some embodiments, the suspension of the present invention may have a viscosity of about 2000 cP and a density of about 1.9 g/cc.

According to some embodiments, the suspension may further include at least one dispersant selected from the group including nonionic surfactants formed by the ethoxylation of sorbitan; A blend of polyethoxylated alkyl amines (C8-C18) alkyl polyoxyethylene glycols and organic acids; Sodium hexametaphosphate (SHMP); hydrotropes; wetting agents; super-wetting agents; nonionic surfactants; nonionic surfactants that have a hydrophilic polyethylene oxide chain; sodium polymethacrylate dispersing agents and the like.

As is known in the art, a stable dispersion of a powder in a liquid is a process whereby aggregates and agglomerates of powders are dispersed into individual units usually followed by a wet milling process and stabilization of the resulting suspension against aggregation and agglomeration sediments.

According to some embodiments, the liquid used in this invention may be water, an accordingly, a hydrophilic solid may be used as a suspending agent, e.g., bentonite clay.

According to some embodiments, in ordinary suspension particles may undergo aggregation during shelf time because of van der Waals or dipole attraction forces. According to some embodiments, to overcome this attraction energy, it is essential to have a repulsive energy between the particles or to create a three-dimensional gel that thickens the suspension and holds the suspension homogeneous.

According to some embodiments, since the particle density is usually larger than that of the medium, the particles tend to sediment to a compact sediment that may be very difficult to redisperse once again.

According to some embodiments, the present invention uses suspending agents, such as thickeners and clays, to produce a gel network with high viscosity preventing particle sedimentation.

According to some embodiments, one of the targets of the present invention is to prepare a stable suspension with a long shelf life (>2 months, preferably >3 months) without applying constant agitation.

According to some embodiments, the suspension of the present invention may include using a sulphate salt, e.g., Polyhalite or Kieserite, in any particle size under 2 mm with preferably a particle size distribution that contains large particles within the range between 0.5-2.0 mm.

According to some embodiments, it may be challenging to bring all particle sizes to yield a homogeneous suspension, avoid sedimentation or avoid the necessity to apply constant agitation just to keep the suspension stable.

According to some embodiments, in order to prepare a flowable and a stable suspension it may be extremely challenging to find or use the right suspending agent among the endless possibilities.

In addition, specifically for the suspension of the present invention, one of the main challenges was to find the right suspending agent that will form a stable net to hold large particles and lower the tendency of settling down and coagulating to a one block that cannot be suspended.

According to some embodiments, the unique particle size and water swelling capability of the suspending agents used in the present invention allow for the formation of a stable suspension that does not require reducing the size of the sulphate salt to be homogeneously below 0.5 mm.

According to some embodiments, there is provided herein a method for the preparation of a sulphate salt suspension, comprising: Pre-mixing water (for example, reverse osmosis water) with one or more suspending agents via mechanical stirring; Adding said sulphate salt in three steps (equal amounts) while mixing via mechanical stirring; and wherein said sulphate salt is in a concentration of at least 50% w/w.

According to some embodiments, the sulphate salt may be selected from the group including Anhydrite, Polyhalite, Gypsum, Kieserite, Epsomite. Glauberite, Blodite, Langbeinite, Kainite, Schonite, Calcium sulphate, potassium magnesium and sulfur fertilizers.

According to some embodiments, the sulphate salt may preferably be Polyhalite or Kieserite.

According to some embodiments, the suspending agent may be in a concentration of between 0.2%-1% w/w.

According to some embodiments, it was found important to add the polyhalite in more than one step, preferably, in three steps, in order to avoid friction heat formed during mixing and to defend the mechanical stirrer from damage. According to some embodiments, it was also found that when using a three step addition of the Polyhalite, a more homogeneous suspension is formed.

According to some embodiments, usually, when adding additives such as xanthan gum to suspend the particles of a suspension, it requires the use of high shear stirrer which may be a more expensive and which also grinds all the particles including the active material to get a homogeneous suspension.

According to some embodiments, the present invention enables to overcome these drawbacks by uniquely using a mechanical stirrer.

According to some demonstrative embodiments, there is provided herein a polyhalite (also referred to herein as “Polysulphate”) suspension and a process for the production thereof.

According to some demonstrative embodiments, there is provided herein a highly concentrated polyhalite suspension comprising at least 50% w/w polyhalite, preferably, at least 60% w/w, more preferably at least 70% w/w.

According to some embodiments, the polyhalite may be produced from the standard grade of polyhalite, for example, having a particle size of less than 2 mm, d50=760 μm.

According to some embodiments, at high concentrations, for example, higher than 15% w/w Polyhalite tends to precipitate and one of the ways to at least partially overcome this precipitation is by attempting to grind the polyhalite to powder particles, e.g., having a size of less than 0.4 mm. However, according to some other embodiments, the present invention allows for the formation of a stable polyhalite suspension using polyhalite particles, for example using polyhalite particles wherein at least 80% of the particles have a mean size of at least 0.5 mm.

According to some embodiments, in the present invention, polyhalite particles (e.g., standard) may be sieved before preparation of the suspension, for example, by using a sieve having 710 micrometer opening.

According to some demonstrative embodiments, the suspension of the present invention may include adding polyhalite into water at a concentration of at least 50% w/w, preferably at least 70% w/w, optionally with a dispersant (also referred to as a “stabilizer”).

According to some embodiments, it is known that polyhalite at high concentrations in an aqueous environment tends to precipitate. As such, the present invention provides a unique solution to this challenge in creating a stable suspension of high concentrations of Polyhalite.

According to some embodiments, the term “stable” as used herein may refer to a suspension which is essentially uniform, i.e., does not include two or more separated sediments but a single fraction.

According to some embodiments, the suspension of the present invention may be stable for at least a month, preferably more than 2 months, and most preferably at least 3 months, from the moment of creation.

According to some embodiments, most of the suspensions are composed of soluble salts, and in the case of fertilizers, can be used for foliar spraying. However, many sulphate salts, for example, Polyhalite which is a slow solubility mineral and as such, the use thereof in a suspension purposes is extremely challenging as spraying nozzle will clog up or congest.

According to some other embodiments, there is provided herein a use of the sulphate salt suspension of the present invention for fertilization of a crop or field, wherein the use may include adding a substance to the suspension, e.g., to enhance fertilization.

According to these embodiments, the existence of the sulphate salt, e.g., polyhalite, in the form of a suspension allows for the effective mixing and/or combination with other substances.

According to some embodiments, the substances that may be added to the suspension of the present invention may include, but not limited to, Bio stimulants, Micro-organisms, Organic fertilizers and the like.

According to some embodiments, the suspension of the present invention may allow for effectively spreading of low solubility fertilizers, specifically sulphate salts, e.g., sparingly soluble sulphate salts, preferably polyhalite.

According to some embodiments, when the suspension of the present invention comes in contact with soil, potassium is the first nutrient to be released.

According to these embodiments, the quick and complete release of potassium from the polyhalite mineral, e.g., when specifically used in a suspension according to the present invention, allows for high quantities of potassium to be absorbed by the plant, which, as mentioned earlier, plays an important role in the development of the plant. According to some embodiments, other important nutrients for the plant are released soon thereafter.

According to some embodiments, the suspension may include one or more suspending agents which act as rheological additives, such as clays, preferably, organically modified and/or beneficiated smectite clays, such as for example, polysilicates or industrial smectite clays, e.g., for use in systems containing high levels of dissolved electrolytes, such as Magnesium Aluminum Silicate (for example VAN GEL® ES); Colloidal magnesium aluminum silicates, such as VAN GEL® B; Microcrystalline Cellulose and/or Cellulose Gums, for example, Avicell® 611.

According to some preferred embodiments of the present invention, the clay may preferably be an organically modified and/or beneficiated smectite clays, such as for example, BENTONE® DY CE.

According to some embodiments, the suspending agent may be a clay, and used in concentration of between 0.2%-1.0% w/w.

According to some demonstrative embodiments, the unique use of clay, especially in low concentrations, e.g., below 1% w/w allows for the formation of a three dimensional network structure which creates repelling forces between the sulphate salt particles, thus preventing their agglomeration and precipitation. According to some embodiments, the use of the clay may facilitate the fluidization of the sulphate salts particles in an aqueous suspension.

According to some embodiments there is provided herein a sulphate salt suspension, comprising: a sulphate salt, e.g, Polyhalite or Kieserite, in a concentration of at least 50% w/w; and a clay in a concentration of between 0.2%-1% w/w.

According to some embodiments, the suspension of the present invention may further include one or more dispersants in addition to the suspending agent, wherein the dispersant may include any suitable substance which may decrease the viscosity of the sulphate salt and/or prevent or delay the separation of the suspension into two or more separate fractions, and/or prevent or diminish the formation of precipitates.

According to some embodiments, the one or more dispersants may be selected from the group including, for example, nonionic surfactants formed by the ethoxylation of sorbitan, e.g., Polysorbate such as Polysorbate 20 (also known as Tween 20); A blend of polyethoxylated alkyl amines (C8-C18) alkyl polyoxyethylene glycols and organic acids (also known as “Optima”); Sodium hexametaphosphate (SHMP); hydrotropes, for example hydrotropes for non-ionic surfactants such as N-octylphosphonic acid (Also referred to herein as SURFARON); wetting agents and/or super-wetting agents, such as N-Octyl-2-Pyrrolidone based wetting agents, for example Easy-Wet™; nonionic surfactants, preferably nonionic surfactants that have a hydrophilic polyethylene oxide chain such as Polyethylene glycol p-(1,1,3,3-tetramethylbutyl)-phenyl ether (also known as Triton X-100); sodium polymethacrylate dispersing agents, for example, DARVAN 7-N® and the like.

According to some embodiments, a combination of dispersants may be used, for example, a combination of a clay and N-octylphosphonic acid. According to some embodiments, the clay may be used in a concentration between 0.1-1.5% w/w, preferably between 0.3%-0.7% w/w, and the N-octylphosphonic acid may be used in a concentration of between 0.2%-1% w/w, preferably between 0.5-0.6% w/w.

According to some demonstrative embodiments, the suspension of the present invention may possess a viscosity of about 2000 cp-4000 cp and a density of 1.2-2.5 g/ml, preferably 1.8-1.9 g/ml.

According to some demonstrative embodiments, there is provided herein a method for the preparation of a sulphate salt suspension, comprising:
Pre-mixing water with an organically modified clay via mechanical stirring, for example, at 250 rpm for 10 minutes
Adding the sulphate salt in three steps (equal amounts) while mixing via mechanical stirring, for example, at 200 rpm for 10 minutes.

According to some embodiments, the sulphate salt may preferably be polyhalite.

According to some embodiments, the suspension is a polyhalite suspension 50% w/w, preferably a polyhalite suspension 70% w/w.

According to some embodiments, the clay may be at a concentration of between 0.2%-1% w/w, preferably between 0.3%-0.7% w/w, most preferably, 0.5% w/w.

According to some demonstrative embodiments, there is provided herein a method for the preparation of a polyhalite suspension, e.g., 70% w/w suspension, comprising:
Pre-mix reverse osmosis (RO) water with of organically modified clay (for example, Bentone DY CE), e.g., at a concentration of 0.5% w/w using mechanical stirring, e.g., at 250 rpm for 10 minutes.
Adding N-octylphosphonic acid (Surfaron®), for example at a concentration of 1.0% w/w.
Adding polyhalite in three steps (equal amounts) while mixing via mechanical stirring, for example, at 200 rpm for 10 minutes.

According to some embodiments, the sulphate salt suspension may be used in agricultural applications, including but not limited to soil conditioning and fertilization.

According to some preferable embodiments, the suspension of the present invention may be particularly useful when applied to manure of an animal, for example, for reducing the emissions of NH₃.

In other embodiments, the sulphate salt suspension may be used in industrial applications such as water treatment or as an additive in construction materials.

According to further embodiments, the suspension may include additional agents such as colorants, preservatives, or anti-caking agents.

According to some embodiments, the highly concentrated sulphate salt suspension may include a viscosity modifier to facilitate pumping or spraying of the suspension, including, but not limited to, polymers, such as, Xanthan Gum, Hydroxyethyl Cellulose (HEC), Polyvinyl Alcohol (PVA); associative thickeners such as, Hydrophobically-modified Ethoxylate Urethanes (HEUR), Hydrophobically-modified Alkali-soluble Emulsions (HASE); inorganic agents such as, Silica Gel, Fumed Silica; organic compounds, such as, polyacrylates, alginates, guar gum and the like.

In another embodiment, the highly concentrated sulphate salt suspension may include additional salts or minerals to provide multi-functional capabilities.

In further embodiments, the highly concentrated sulphate salt suspension may be configured for time-released applications, wherein the salt dissolves over an extended period.

In another embodiment, the polyhalite may be pre-treated, for example by heat or chemical treatment, to modify its solubility or other properties before forming the suspension.

### Example 1

For all examples a standard grade of polyhalite was used. The standard grade was sieved with 1 mm sieve. Fraction of less than 1 mm (65.2% w/w) was used for the suspension.

1.1. Vial Tests of Polyhalite Suspension with Various Dispersants

polyhalite suspensions of 50% w/w and 70% w/w were prepared and tested with the following dispersants and stabilizers by vial test, as shown in table 1 (concentrations are in w/w):

TABLE 1

| Dispersant/ | Concentration |
|---|---|
| stabilizer | (% w/w) |
| Tween 20 | 1.0 |
| Triton X-100 | 1.0 |
| Optima | 1.0 |
| SHMP | 3.0 |
| Easy wet | 1.0 |
| Surfaron | 1.0 |
| Avicell 611 | 1.5 |
| Van gel es | 2.0 |
| Van gel b | 2.0 |
| Benton dy-ce | 1.0 |
| Darvan 7N | 1.0 |

For 10.0 g of 50% w/w and 70% w/w suspension each of the above stabilizers was added into the vial and mixed. Comparison was performed with blank samples that contained only polyhalite suspension without additives.

1.2. Preparation of 250.0 g Polyhalite Suspension after Screening Dispersants

After screening the stabilizers, for which gave good results: full stability or stabilizer that prevented formation of a sedimentation that cannot be suspended. 250.0 g of suspension was prepared.

### 2. Results:

### 2.1. Vial Tests

All vials stood for a day without moving. After 24 hours, each vial was shaken to test which stabilizer prevents formation of a mass block.

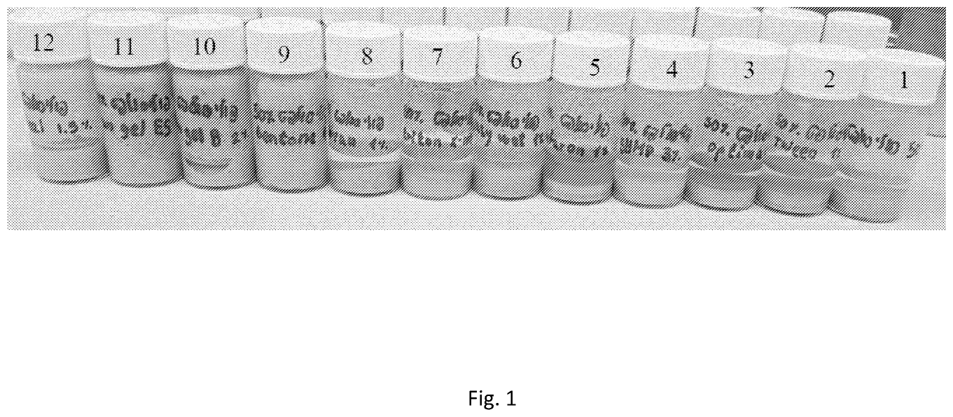

The results are demonstrated in table 2 and FIG. 1.

TABLE 2

| Dispersant/ | |
|---|---|
| stabilizer | Results |
| No stabilizer | Phase separation obtained and a mass block formed |
| Tween 20 | Phase separation, but layers detach easily from the vial by |
| | simply shaking the vial |
| Triton X-100 | Phase separation obtained and a mass block formed |
| Optima | Phase separation obtained and a mass block formed |
| SHMP | Phase separation, but layers detach easily from the vial by |
| | simply shaking the vial |
| Easy wet | Phase separation obtained and a mass block formed |
| Surfaron | Phase separation, but layers detach easily from the vial by |
| | simply shaking the vial |
| Avicell 611 | Phase separation, but layers detach easily from the vial by |
| | simply shaking the vial |
| Van gel ES | Phase separation, but layers detach easily from the vial by |
| | simply shaking the vial |
| Van gel B | Phase separation, but layers detach easily from the vial by |
| | simply shaking the vial |
| Benton | Phase separation, but layers detach easily from the vial by |
| DY-CE | simply shaking the vial |
| Darvan 7N | Phase separation obtained and a mass block formed |

Reference is now made to FIG. 1 which depicts the vial tests of 50% w/w Polyhalite suspension with various stabilizers as shown in table 3 below:

TABLE 3

| Dispersant/stabilizer | No. |
|---|---|
| No stabilizer, 50% w/w polysulphate | 1 |
| Tween 20 | 2 |
| Optima | 3 |
| SHMP | 4 |
| Surfaron | 5 |
| Easy wet | 6 |
| Triton X-100 | 7 |
| Darvan 7N | 8 |
| Benton DY-CE | 9 |
| Van gel B | 10 |
| Van gel ES | 11 |
| Avicell 611 | 12 |

According to some embodiments, as shown in FIG. 1, in example 1 a suspension of 50% w/w polyhalite at in water was tested with various dispersants.

As can be seen from FIG. 1 a 50% w/w suspension of polyhalite in water forms three layers.

This test indicates that smectite clay (Bentone® DY CE) may provide the best results as it keeps the suspension without phase separation.

### Example 2

According to some embodiments, in example 2 a 70% w/w suspension of polyhalite in water was tested with various dispersants.

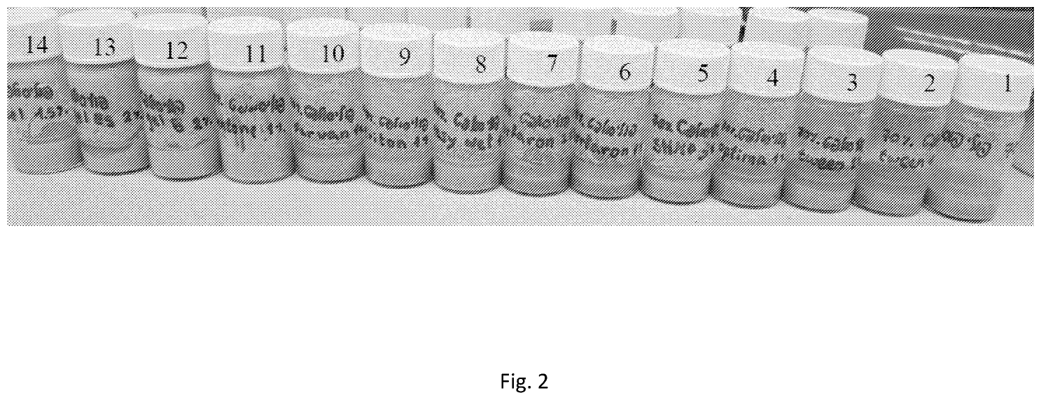

Reference is now made to FIG. 2 which depicts the vial tests of 70% w/w Polyhalite suspension with various stabilizers as shown in table 4 below:

TABLE 4

| Dispersant/stabilizer | No. |
|---|---|
| No stabilizer, 70% w/w polysulphate | 1 |
| Tween 20, 1% | 2 |
| Tween 20, 2% | 3 |
| Optima | 4 |
| SHMP | 5 |
| Surfaron, 1% | 6 |
| Surfaron, 2% | 7 |
| Easy wet | 8 |
| Triton X-100 | 9 |
| Darvan 7N | 10 |
| Benton DY-CE | 11 |
| Van gel B | 12 |
| Van gel ES | 13 |
| Avicell 611 | 14 |

As can be seen from the results, a 70% w/w suspension of polyhalite in water forms three layers, and it can be seen that smectite clay (Bentone® DY CE) is the best candidate since it keeps the suspension without phase separation.

### Example 3

### a Method for the Preparation of a Polyhalite Suspension:

A 70% w/w polyhalite suspension was prepared with 0.5% w/w of an organically modified beneficiated smectite clay (Bentone® DY CE) as follows:
Pre-mix of RO water with the clay. Mixing was performed by a mechanical stirring at 250 rpm for 10 minutes.
Adding polyhalite in three steps (equal amounts) while mixing. Mixing was performed by a mechanical stirring at 200 rpm for 10 minutes.

Suspension remained stable for a month. Viscosity at 100 rpm: 1340 cP.

### Example 4

A 70% w/w polyhalite suspension was prepared with 1.0% w/w of organically modified beneficiated smectite clay (Bentone DY CE) and 0.5% w/w of N-octylphosphonic acid (Surfaron®) as follows:
Pre-mix of water with the clay. Mixing was performed by a mechanical stirring at 250 rpm for 10 minutes.
Adding N-octylphosphonic acid (Surfaron®) to the pre-mix.
Adding polyhalite in three steps (equal amounts) while mixing. Mixing was performed by a mechanical stirring at 200 rpm for 10 minutes.

Suspension remained stable for a month. Viscosity at 100 rpm: 727 cP.

### Example 5

A 70% w/w polyhalite suspension was prepared with 0.3% w/w of organically modified beneficiated smectite clay (Bentone DY CE) and 0.6% w/w N-octylphosphonic acid (Surfaron®) as follows:
Pre-mix of water with the N-octylphosphonic acid. Mixing was performed by a mechanical stirring at 250 rpm for 2 minutes.
Adding the clay to the pre-mix. Mixing at 250 rpm for 10 minutes.
Adding polyhalite in three steps (equal amounts) while mixing. Mixing was performed by a mechanical stirring at 200 rpm for 10 minutes.

Suspension remained stable for two weeks. Viscosity at 100 rpm: 550 cP.

### Example 6

### Preparation of Sieved (<1 mm) Standard Polyhalite Suspension

The standard grade was sieved with 1 mm sieve. Fraction of less than 1 mm (65.2%) was used for the suspension.

A 70% Polyhalite suspension was prepared with 0.5% w/w smectite clay (Bentone DY CE) and as follows:
Pre-mix of RO water with smectite clay (Bentone DY CE). Mixing was performed by a mechanical stirring at 250 rpm for 10 minutes.
Adding Polyhalite in three steps (equal amounts) while mixing.
Mixing was performed by a mechanical stirring at 200 rpm for 10 minutes.

Quantities of raw materials for the preparation of 70% w/w sieved polyhalite suspension are shown in table 5:

| Raw material | Quantity (g) |
|---|---|
| water | 73.75 |
| smectite clay | 1.25 |
| (Bentone DY CE) | |
| polyhalite | 175.0 |
| Total | 250.0 |

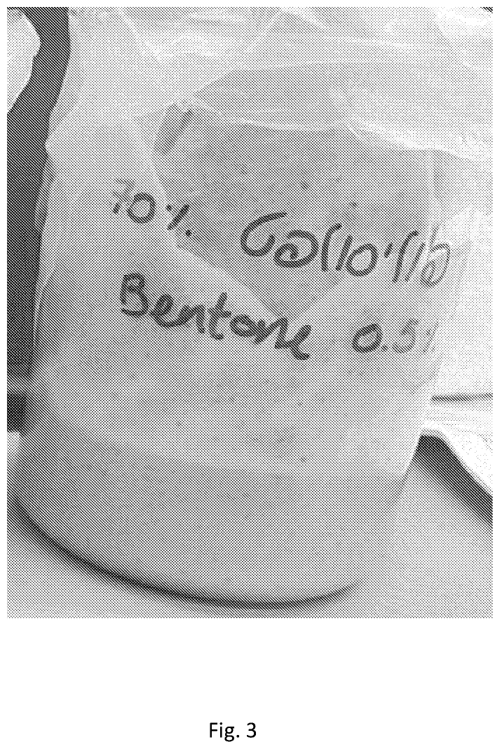

Reference is now made to FIG. 3, which demonstrates the resulting Polyhalite suspension of table 5.

### Example 7

A 70% Polyhalite suspension was prepared with 1.0% w/w N-octylphosphonic acid (Surfaron®) and 0.5% w/w smectite clay (Bentone DY CE) as follows:
Pre-mix of RO water with smectite clay. Mixing was performed by a mechanical stirring at 250 rpm for 10 minutes.
Adding N-octylphosphonic acid to the pre-mix.
Adding Polyhalite in three steps (equal amounts) while mixing. Mixing was performed by a mechanical stirring at 200 rpm for 10 minutes.

Quantities of raw materials for the preparation of 70% w/w sieved polyhalite suspension are shown in table 6:

| Raw material | Quantity (g) |
|---|---|
| water | 71.25 |
| smectite clay | 1.25 |
| N-octylphosphonic acid | 2.5 |
| polyhalite | 175.0 |
| Total | 250.0 |

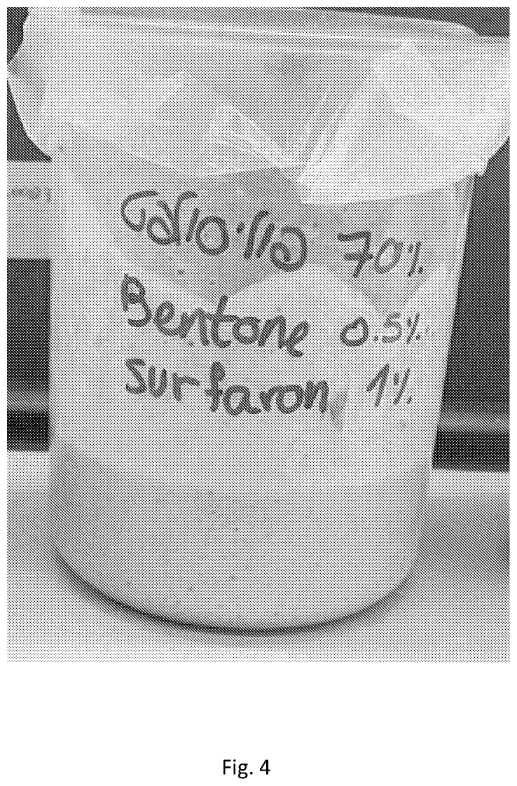

Reference is now made to FIG. 4, which demonstrates the resulting Polyhalite suspension of table 6.

### Example 8

### Preparation of Standard (<2 mm) Polyhalite Suspension

This work describes preliminary results for the development of a stable standard polyhalite suspension at concentration of 50-70% w/w and polyhalite suspension based on sieved polyhalite.

Viscosity measurements were conducted by Brookfield digital viscometer at 100 rpm and 50 rpm. Suspensions were stored in a plastic 100 ml cup with a red plastic cover.

### Suspension Preparation:

For the preparation of the suspension, a mechanical stirrer was used. Suspensions were prepared at concentrations of 50% w/w and 70% w/w.

### Procedure for the Preparation of Standard Polyhalite Suspension:

Add water to a Polypropylen (PP) beaker.
Add clay while stirring at 250 rpm
Stir for 10-15 minutes.
Add standard polyhalite while stirring *3 doses (divide the amount required to 3 doses)
Keep stirring for 30 minutes

Quantities of raw materials for the preparation of 50% w/w polyhalite suspension are shown in table 8 (trial no. 22):

| Raw material | Quantity (g) |
|---|---|
| water | 123.0 |
| smectite clay | 2.0 |
| polyhalite | 125.0 |
| Total | 250.0 |

Quantities of raw materials for the preparation of 70% w/w polyhalite suspension are shown in table 9 (trial no. 25):

| | Quantity |
|---|---|
| Raw material | (g) |
| water | 73.0 |
| smectite clay | 1.25 |
| N-octylphosphonic acid | 0.75 |
| polyhalite | 175.0 |
| Total | 250.0 |

The following table will describe data regarding Flowable and stable polyhalite suspensions observed for 3 months. viscosity measurements were performed with SPDL 3 immediately after preparation at 100 rpm and 50 rpm.

Table 10 summarizes the most flowable standard polyhalite suspensions:

| | Clay | Dispersant | Viscosity | Viscosity |
|---|---|---|---|---|
| Type of | conc. | conc. | @100 rpm | @50 rpm |
| clay | (% w/w) | (% w/w) | (cps) | (cps) |
| smectite | 0.8 | 0.0 | 810*10\hat{ }0 | 1.3*10\hat{ }3 |
| clay | | | | |
| smectite | 0.5 | 0.3 | 1.22*10\hat{ }3 | 1.87*10\hat{ }3 |
| clay | | | | |

According to some embodiments, the suspension was prepared based on un-sieved standard Polyhalite, having particle size higher than 1 mm and less than 2 mm. Usually, most suspensions undergo sedimentation on standing due to gravity and the density difference between the particles and dispersion medium. In this case Brownian diffusion cannot overcome the gravity force and sedimentation occurs resulting in increasing particle concentration from the top to the bottom of the container. The bigger the particle size the higher difficulty to stabile.

While this invention has been described in terms of some specific examples, many modifications and variations are possible. It is therefore understood that within the scope of the appended claims, the invention may be realized otherwise than as specifically described.

1. A suspension comprising at least one sulphate salt in a concentration of at least 50% w/w; and
at least one suspending agent.

2. The suspension of claim 1, wherein said sulphate salt is selected from the group including Anhydrite, Polyhalite, Gypsum, Kieserite, Epsomite. Glauberite, Blodite, Langbeinite, Kainite, Schonite, Calcium sulphate, potassium magnesium and sulfur fertilizers.

3. The suspension of claim 2, wherein said sulphate salt is in a concentration of at least 60% w/w.

4. The suspension of claim 3, wherein said sulphate salt is Polyhalite.

5. The suspension of claim 3, wherein said sulphate salt is Kieserite.

6. The suspension of claim 4, wherein said polyhalite is in a concentration of at least 70% w/w.

7. The suspension of claim 3, wherein said suspending agent is in a concentration of between 0.2%-1% w/w.

8. The suspension of claim 7, wherein said suspending agent is a clay selected from the group including organically modified smectite clays; beneficiated smectite clays; Colloidal magnesium aluminum silicates; Microcrystalline Cellulose and Cellulose Gums.

9. The suspension of claim 8, wherein said clay is an organically modified beneficiated smectite clay.

10. The suspension of claim 3, comprising a viscosity of about 2000 cP and a density of about 1.9 g/cc.

11. The suspension of claim 7, further comprising at least one dispersant selected from the group including nonionic surfactants formed by the ethoxylation of sorbitan; A blend of polyethoxylated alkyl amines (C8-C18) alkyl polyoxyethylene glycols and organic acids; Sodium hexametaphosphate (SHMP); hydrotropes; wetting agents; super-wetting agents; nonionic surfactants; nonionic surfactants that have a hydrophilic polyethylene oxide chain and sodium polymethacrylate dispersing agents.

12. A method for the preparation of a sulphate salt suspension, comprising:
Pre-mixing water with a suspending agent via mechanical stirring;
Adding said sulphate salt while mixing using a mechanical stirrer; and
wherein said sulphate salt is in a concentration of at least 50% w/w.

13. The method of claim 12, wherein said sulphate salt is selected from the group including Anhydrite, Polyhalite, Gypsum, Kieserite, Epsomite. Glauberite, Blodite, Langbeinite, Kainite, Schonite, Calcium sulphate, potassium magnesium and sulfur fertilizers

14. The method of claim 13, wherein said sulphate salt is Polyhalite.

15. The method of claim 14, wherein adding said sulphate salt is done in three steps (equal amounts).
